(19) United States
(12) Patent Application Publication
(10) Pub. No.: US 2005/0108761 A1
(43) Pub. Date: May 19, 2005

(54) Apparatus and method for processing digital cable broadcasting signals

(76) Inventor: Ja-Bong Cheon, Yongin-si (KR)

Correspondence Address: Robert E. Bushnell, Suite 300, 1522 K Street, N.W., Washington, DC, 20005, US

(21) Appl. No.: 10/987,084

(22) Filed: Nov. 15, 2004

(30) Foreign Application Priority Data
Nov. 18, 2003 (KR) 2003-81872

(51) Int. Cl. H04N 7/173; H04N 7/18; H04N 7/10; H04N 5/50

(52) U.S. Cl. 725/80; 725/74; 725/100; 725/131; 348/731

(57) ABSTRACT

An apparatus and method for processing a broadcasting signal of the Open Cable device, and this invention makes it possible to provide a user with broadcast services based on an “open cable standard” and a “digital cable broadcasting data standard” for commercialization of Korean digital cable broadcasting using one device.

### CLAIM OF PRIORITY

This application makes reference to, incorporates the same herein, and claims all benefits accruing under 35 U.S.C. §119 from an application for APPARATUS AND METHOD FOR PROCESSING BROADCASTING SIGNAL earlier filed in the Korean Intellectual Property Office on 18 Nov. 2003 and there duly assigned Serial No. 2003-81872.

### BACKGROUND OF THE INVENTION

1. Field of the Invention

The present invention relates to an apparatus and method for processing a broadcasting signal and, more particularly, to an apparatus and method for processing a broadcasting signal, capable of receiving the broadcasting signal according to both an “Open Cable standard” and a “digital cable broadcasting data standard”, and providing digital TV broadcasting services to a user who has an analog TV set without requiring the user to buy a new television receiver.

2. Description of the Prior Art

In recent years, there is increased interest in digital cable TV. The transmission standards for digital cable TV service include the Open Cable standard in the US, DVB-C (Digital Video Broadcasting-Cable) standard in Europe, and ISDB-C (Integrated Services Digital Broadcasting for Cable) standard in Japan, etc.

Among the transmission standards for the digital cable TV, in the US, Open Cable standard is based on the “Telecom Act” or broadcasting and telecommunication convergence Act, which was passed by FCC (Federal Communication Commission) in United States in 1996. This Act makes it possible for user to purchase a set-top box from which a security module was separated. The CableLabs organizes the Open Cable standard and begins a standardization project based on the set-top box from which security module was separated. By 2005, it will be required that the set-top box must be separated from the safety module.

The Open Cable standard is based on MPEG-2 (Motion Picture Experts Group) as the video standard and DOCSIS (Data Over Cable Service Device Specification) as the transmission standard for the cable modem. Also, the Open Cable standard defines all contents serviced by the digital cable TV, digital broadcasting, bi-directional interactive service and information service in addition to defining the interoperability and compatibility between these services.

Moreover, a modulation scheme of a broadcasting signal according to the Open Cable standard uses 64-QAM (quadrature amplitude modulation) and 256-QAM. This digital modulation scheme is suitable to transmit data within a limited transmission bandwidth at a higher efficiency. Also, a video encoding scheme of the Open Cable standard adopts MPEG-2, and is the same as the scheme for Korean terrestrial digital television (DTV) and satellite broadcasting. And, because of a characteristic that moves to sound center, right and left, surround right and left, an audio encoding scheme is similar to the scheme used for the Korean terrestrial DTV with “Dolby AC-3” having dynamic sound effects of movie theater quality. Thus, the audio encoding scheme is advantageous in view of compatibility, but it is disadvantageous in that, when the satellite broadcasts using “MPEG-2” scheme, the audio signal is required to be converted because it is different from the “MPEG-2” scheme.

Furthermore, a multiplexing scheme by which various programs including a video and an audio are united into one makes use of MPEG-2 TS (Transport Stream) which multiplexes information stream in a unit of packet using an error correction code and which is more efficiently transmitted compared to PS (Program Stream). The multiplexing scheme is the same as the scheme for the terrestrial DTV and satellite broadcasting. An upstream frequency band necessary for bi-directional service ranges from 5 MHz to 42 MHz, and a downstream channel bandwidth of 6 MHz is the same as that for a Korean channel environment. A broadcasting protocol is specified to use out-of-band SI (Service Information) and in-band PSIP (Program and System Information Protocol).

Therefore, there is a need for development of the Open Cable terminal equipment suitable for both the “Open Cable standard” and the “digital cable broadcasting data standard” for commercialization of Korean digital cable broadcasting. Also, it is necessary for a subscriber using the existing analog TV to be provided with the digital television broadcast service, without requiring the consumer to replace an analog TV set with digital television set or requiring the consumer to expend extra charges in purchasing any separate device.

### SUMMARY OF THE INVENTION

It is therefore an object of the present invention to provide an apparatus that provides digital cable TV service to an analog TV receiver where the digital cable TV service can be either an “Open Cable standard” or a “digital cable broadcasting data standard”.

It is also an object of the present invention to provide a method for processing digital TV cable signals from either of these two standards.

Accordingly, the present invention is made to solve the above-mentioned problems occurring in the prior art, and an objective of the present invention is to provide an apparatus and method for processing a broadcasting signal enabling to receive all broadcasting signals based on the “Open Cable standard” and the “digital cable broadcasting data standard” for commercialization of Korean digital cable broadcasting and to provide them to analog TV and digital TV.

In order to accomplish the objective, an apparatus for processing a broadcasting signal according to one aspect of the present invention includes a receiving unit for receiving the broadcasting signal provided from a broadcasting service provider, a signal distribution unit for distributing and providing the broadcasting signal received by the receiving unit, according to a processing method of the broadcasting signal, a gain control unit for controlling a gain according to the processing method of the broadcasting signal provided from the signal distribution unit, an analog processing unit for tuning and demodulating the broadcasting signal whose gain is controlled according to an analog processing method in the gain control unit, and a digital processing unit for tuning the broadcasting signal whose gain is controlled according to a digital processing method in the gain control unit.

Furthermore, the apparatus for processing the broadcasting signal according to the present invention further includes a transmission unit for transmitting a selection signal generated by user's selection to the broadcasting service provider, an RF processing unit for outputting an RF broadcasting signal with TV connected to a cable when the broadcasting signal provided from the signal distribution unit is the RF broadcasting signal, and a specific channel processing unit for converting the broadcasting signal generated from the signal distribution unit to a specific channel and for outputting the result signal.

A method for processing a broadcasting signal according to another aspect of the present invention includes receiving the broadcasting signal from a broadcasting service provider, distributing the received broadcasting signal so that it can demodulate the received broadcasting signal according to different processing methods of the broadcasting signal respectively, and demodulating the distributed broadcasting signal according to the different processing methods of the broadcasting signal, respectively.

Furthermore, the method for processing the broadcasting signal according to the present invention further includes compensating for signal attenuation occurring in the distributed broadcasting signal, and controlling a frequency band of respective signals to avoid a collision between the broadcasting signal and the selection signal in the case that there is a selection signal to be transmitted to the broadcasting service provider.

Furthermore, in the method for processing the broadcasting signal according to the present invention, the demodulating step includes providing an RF broadcasting signal in the broadcasting signal to analog TV connected to a cable, converting the broadcasting signal into a specific channel (CH3 or CH4), and providing the converted broadcasting signal to a specific channel TV, tuning an analog broadcasting signal in the broadcasting signal, converting the tuned broadcasting signal into a broadcasting signal of a base band, and providing the converted broadcasting signal to analog TV, and tuning a specific digital RF (radio frequency) signal of a digital broadcasting signal, converting the tuned signal into an IF (intermediate frequency) signal, providing the converted broadcasting signal to digital TV.

### BRIEF DESCRIPTION OF THE DRAWINGS

A more complete appreciation of the invention, and many of the attendant advantages l thereof, will be readily apparent as the same becomes better understood by reference to the following detailed description when considered in conjunction with the accompanying drawings in which like reference symbols indicate the same or similar components, wherein:

FIG. 1 is an internal block diagram for explaining the construction of an apparatus for processing a broadcasting signal according to a preferred embodiment of the present invention; and

FIG. 2 is a flowchart for explaining the process of a method for processing a broadcasting signal of the Open Cable device according to a preferred embodiment of the present invention.

### DETAILED DESCRIPTION OF THE INVENTION

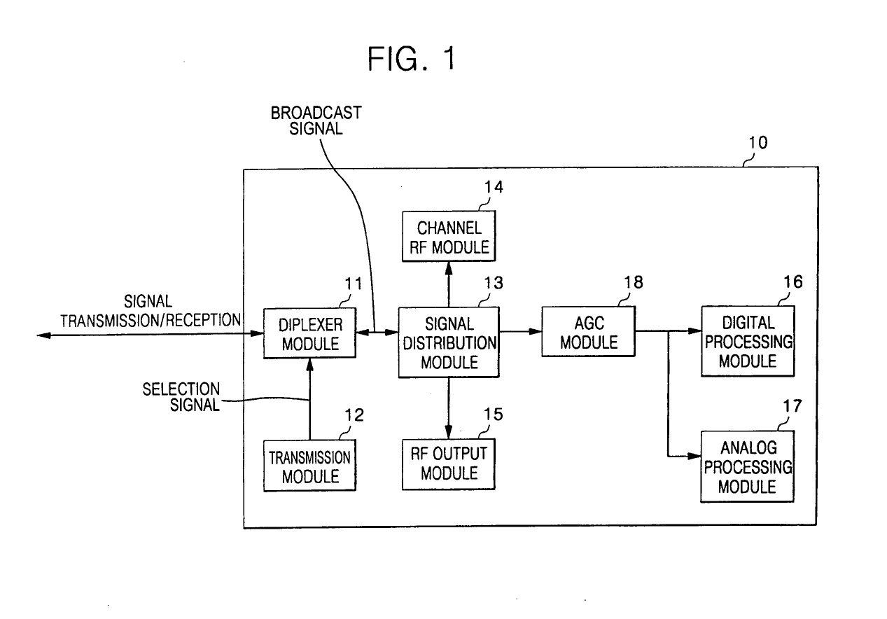

Turning now to the figures, FIG. 1 is an internal block diagram illustrating the construction of an apparatus 10 for processing broadcasting signals according to a preferred embodiment of the present invention. Referring to FIG. 1, the apparatus 10 for processing the broadcasting signals according to the present invention includes a diplexer module 11, a transmission module 12, a signal distribution module 13, a channel RF (Radio Frequency) module 14, a RF output module 15, an AGC (Amplifier Gain Control) module 18, a digital processing module 16, and an analog processing module 17.

The transmission module 12 transmits a selection signal generated from a CPU (not shown) of the set-top box to a broadcasting service provider server (not shown) via a cable according to user's selection. This selection signal is sent through the diplexer module 11 and out to the cable service provider. Because both the selection signal and the broadcast signals go through the diplexer 11, it is the job of the diplexer 11 to keep both of these signals from mixing or interfering with each other and to handle each of these signals in a separate manner. Therefore, the diplexer module 11 serves to prevent the selection signal from interfering with the broadcasting signals and vice versa. For example, if a frequency band of the broadcasting signal transmitted from the broadcasting service provider server via the cable ranges from 88 MHz to 860 MHz, the frequency band of the selection signal transmitted to the broadcasting service provider server is 30 MHz, so that interference between the broadcasting signal and the selection signal can be avoided.

The broadcasting signals are relayed through diplexer 11 to signal distribution module 13 while the selection signals are sent, by diplexer 11, back to the cable provider. The broadcasting signals are transmitted using channels, protocols, etc., each of which is defined differently. Thus, the signal distribution module 13 is capable of sorting and distributing the received broadcasting signals by checking the received broadcasting signals with regard to their channels, protocols and so forth. Definition of each broadcasting signal may be confirmed from various standards such as “Standard for Digital Cable Television Transmitter/Receiver Interface,” DOCSIS Set-to Gateway (DsG) Interface Specification,” etc. Therefore, their detailed descriptions will be omitted.

The signal distribution module 13 then distributes the broadcasting signals received through the cable and provides the distributed signal to the channel RF module 14, the RF output module 15, and the AGC module 18. The signal distribution module 13 separates and distributes the analog broadcasting signals from the digital broadcasting signals, depending upon the kind of the broadcasting signal, and transmits the received broadcasting signal to the channel RF module 14 and the RF output module 15 according to user's setting. The apparatus for processing the broadcasting signal provides the broadcasting signal to the existing analog TV set, the TV set receiving the broadcasting signal over the specific channel, or the digital TV set according to user's setting. Furthermore, it is desirable that the signal distribution module 13 compensate the return loss or insertion loss generated from providing the broadcasting signals to modules 14, 15 and 18. Also, the signal distribution module 13 should be connected to the subsequent stage of the diplexer module 1 1, in order not to cause an effect the selection signal by the compensation of signal loss performed in the signal distribution module 13.

The channel RF module 14 converts the broadcasting signals provided from the signal distribution module 13 and transmits them through a specific channel (channel 3 or channel 4), thereby transmitting the converted signal to the TV set (not shown) receiving the broadcasting signal through the specific channel. In this case, the channel RF module 14 bypasses the broadcasting signal inputted according to user's setting and transmits the bypassed signal to the TV set, or encodes the broadcasting signal, converts the encoded signal into the RF broadcasting signal, and transmits it to the TV set. Then, the RF output module 15 transmits the broadcasting signal provided from the signal distribution module 13 to an analog TV set receiving the RF (radio frequency) signal and connected by the cable.

The AGC module 18 maintains the broadcasting signals transmitted from the signal distribution module 13 at a predetermined level. That is, in order for the digital processing module 16 and the analog processing module 17 to process the broadcasting signal properly, the AGC module 18 keeps the broadcasting signal transmitted from the signal distribution module 13 at the predetermined level. This AGC module 18 may compensate a gain difference between the signal intensity to be fed back from the digital processing module 16 and the analog processing module 17 and the broadcasting signal intensity fed forward from the signal distribution module 13, so that the AGC module 18 maintains the broadcasting signal intensity at the predetermined level.

Also, the AGC module 18 recognizes the kind of the broadcasting signal provided from the signal distribution module 13, and transmits the recognized broadcasting signal to the digital processing module 16 or the analog processing module 17 based on the kind of the broadcasting signal the AGC module 18 receives. Analog broadcasting signals are sent to the analog processing module 17 by the AGC module 18 and digital broadcasting signals are sent to the digital processing module 16 by the AGC module 18. In this case, when the broadcasting signals received through the cable are digital broadcasting signals, the AGC module 18 confirms whether the received signal is an analog broadcasting signal or a digital broadcasting signal according to a current channel frequency, controls the gains resulting from the analog broadcasting signal or the digital broadcasting signal, and provides the gain-controlled signal to the analog processing module 16 and the digital processing module 17, respectively based on whether the signal is analog or digital.

Furthermore, because the AGC module 18 can be operated by either the analog broadcasting signals or the digital broadcasting signals, AGC module 18 can make use of a scheme for controlling the gain of the broadcasting signals in such a manner that, if power is “high,” then the gain of the digital broadcasting signal is controlled, and if power is “low,” then the gain of the analog broadcasting signal is controlled.

Also, the digital processing module 16 converts the broadcasting signal provided by the AGC module 18 into an IF (intermediate frequency) signal by tuning the specific RF signal (256-QAM or 64-QAM modulation signal) from the broadcasting signal. The digital processing module then transmits the converted signal to the CPU of the set-top box where the CPU QAM-modulates the received IF signal and then transmits the modulated signal to the digital TV using the digital broadcasting signal.

The QAM (Quadrature Amplitude Modulation) refers to a kind of multi-level modulation of digital modulations. This modulation uses the combination of both amplitude and phase of the modulated wave (carrier wave) and it is used for transmitting the digital broadcasting signal provided in the Open Cable broadcasting standard.

The analog processing module 17 converts the broadcasting signal provided by the AGC module 18 into the IF signal. Also, the analog processing module 17 processes the signal relating to the NTSC (National Television System Committee) and demodulates the processed signal to the base band signal. The NTSC refers to a serial of TV broadcasting transmission/receiving standard protocol. In this standard, R (Red), G (Green) and B (Blue) signals are matrix-converted to form a luminance signal (Y) and two color difference signals (I, Q), and then sub-carrier signal having a frequency of 3.58 MHz is modulated in image band by means of the two color difference signals. That is, the NTSC standard is the transmission standard of the terrestrial broadcasting signal. In this case, the analog processing module 17 can process the broadcasting signal of either the PAL (Phase Alternation Line) standard or the SECAM (Sequential Couleur a Memoire) standard.

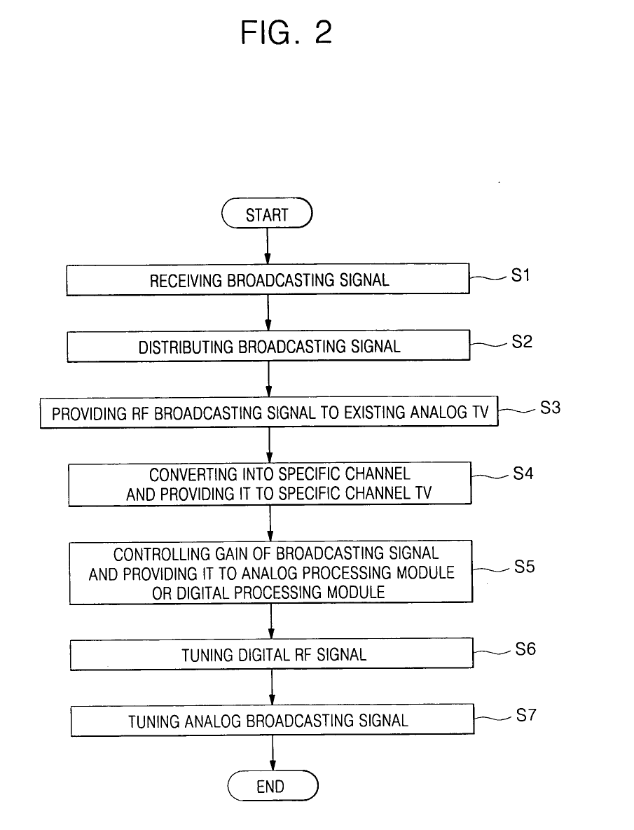

Turning now to FIG. 2, FIG. 2 is a flowchart for explaining the process of processing a broadcasting signal of the Open Cable device according to a preferred embodiment of the present invention. Referring to FIGS. 1 and 2, the diplexer module 11 of the apparatus 10 receives the broadcasting signals via a cable (step S1).

Then, the diplexer module 11 allows a frequency band of the broadcasting signals and a frequency band of the selection signals to be different from each other in order to prevent the broadcasting signals from influencing the selection signals and vice versa. Thus, diplexer 11 serves to transmit the selection signal and the broadcast signal so that the broadcasting signal and the selection signal may not mix with each other or affect one another.

Also, the diplexer module 11 relays the received broadcasting signals to the signal distribution module 13. The signal distribution module 13 distributes the broadcasting signals and provides them to the channel RF module 14, the RF output module 15 and the AGC module 18 (step S2).

In this case, the signal distribution module 13 also compensates for any signal attenuation that occurs during the distribution of the broadcasting signals during transmission to the modules 14, 15 and 18, respectively.

Also, the signal distribution module 13 is located on a subsequent stage from the diplexer module 11 so the signal processing and distribution that occurs in the signal distribution module does not affect the selection signals and vice versa.

If the broadcasting signal received in the signal distribution module 13 is an RF broadcasting signal to be provided to ane existing analog TV set, the RF output module 15 enables a user to be provided with the broadcasting services on the existing analog TV by outputting the received broadcasting signals to the analog TV connected to the cable (step S3).

The channel RF module 14 also performs a conversion of the received broadcasting signals to a specific channel (CH 3 or CH4) and transmits the converted broadcasting signals to the TV receiving the broadcasting signals on the specified channel (step S4).

Here, the channel RF module 14 may bypass the broadcasting signal transmitted from the signal distribution module 13 according to the user's settings or encode the broadcasting signal to an RF broadcasting signal, thereby providing the broadcasting signal to the TV set.

The AGC module 18 controls a gain according to a kind of the broadcast signal to be received from the signal distribution module 13 and transmits the result to the digital processing module 16 or the analog processing module 17 (step S5) based on whether the broadcasting signal is analog or digital.

The AGC module 18 receives a setting indicating whether a channel frequency that a user would like to view is an analog broadcast signal or a digital broadcasting signal. If a digital broadcasting signal is received from the signal distribution module 13, then the AGC module 18 controls the gain of the digital broadcasting signal and provides the controlled digital broadcasting signal to the digital processing module 16. On the contrary, if the analog broadcasting signal is received from the signal distribution module 13, then the AGC module 18 controls the gain of the analog broadcasting signal and provides the controlled analog broadcasting signal to the analog processing module 17.

The digital processing module 16 tunes the received digital RF (radio frequency) signal (64-QAM or 256-QAM modulation signal), converts the tuned signal into the IF (intermediate frequency) signal, and provides the IF signal to the CPU of the set-top box (step S6). The CPU of the set-top box converts the received IF signal into the QAM-modulated signal so that the user can be provided with broadcasting services using a digital TV.

The analog processing module 17 tunes the received analog broadcasting signals provided from the AGC module 18, converts the tuned signal into an IF signal, processes a NTSC demod of the converted IF signal, and demodulates the processed signal to a base band signal (step S7). In this case, the analog processing module 17 can tune the modulated analog broadcasting signal into a PAL (Phase Alternation Line) standard or a SECAM (Sequential Couleur a Memoire) standard in addition to a NTSC (National Television System Committee) standard. Also, the analog processing module 17 transmits the demodulated broadcasting signal of the base band to the CPU of the set-top box. The CPU of the set-top box provides a broadcasting signal of corresponding base band so that a user with an analog TV receiver can be provided broadcasting services.

According to the present invention, it is possible to be provided with the broadcasting services based on the “Open Cable standard” and the “digital cable broadcasting data standard” for commercialization of Korean digital cable broadcasting using one set-top box. And further, a user can be provided with the broadcasting services without regard to kind of standards of broadcast signal, and can be provide with the Open Cable broadcasting services without replacing the existing analog TV set with digital TV set.

Although a preferred embodiment of the present invention has been described for illustrative purposes, those skilled in the art will appreciate that various variation and modifications are possible, without departing from the scope and spirit of the invention as disclosed in the accompanying claims.

1. An apparatus for processing a broadcasting signal, comprising:
a receiving unit adapted to receive the broadcasting signal provided from a broadcasting service provider;
a signal distribution unit adapted to distribute and provide the broadcasting signal received by the receiving unit, according to a processing method for the broadcasting signal;
a gain control unit adapted to control a gain according to the processing method of the broadcasting signal provided from the signal distribution unit;
an analog processing unit adapted to tune and demodulate the broadcasting signal whose gain is controlled according to an analog processing method in the gain control unit; and
a digital processing unit adapted to tune the broadcasting signal whose gain is controlled according to a digital processing method in the gain control unit.

2. The apparatus of claim 1, further comprising:
a transmission unit adapted to transmit a selection signal generated by a user's selection to the broadcasting service provider;
an RF processing unit adapted to output an RF broadcasting signal to a TV connected to a cable when the broadcasting signal provided from the signal distribution unit is an RF broadcasting signal; and
a specific channel processing unit adapted to convert the broadcasting signal provided from the signal distribution unit into a specific channel and adapted to output the resulting signal.

3. The apparatus of claim 1, wherein the signal distribution unit compensates for signal attenuation caused from a distribution of the broadcasting signal.

4. The apparatus of claim 1, wherein the analog processing method is according to a standard selected from the group consisting of NTSC (National Television System Committee), PAL (Phase Alternation Line) and SECAM (Sequential Couleur a Memoire).

5. The apparatus of claim 1, wherein the digital processing method is according to a transmission standard selected from the group consisting of 64-QAM and 256-QAM.

6. A method for processing a broadcasting signal, comprising:
receiving the broadcasting signal from a broadcasting service provider;
distributing the received broadcasting signal for demodulation based on each different processing method; and
demodulating the distributed broadcasting signal according to the different processing methods of the broadcasting signal, respectively.

7. The method of claim 6, further comprising:
compensating for signal attenuation to the broadcasting signal that occurs during distributing; and
controlling a frequency band of the broadcasting signal and a selection signal so that these signals do not interfere with one another.

8. The method of claim 6, wherein demodulating comprises:
providing an RF broadcasting signal in the broadcasting signal to an analog TV;
converting the RF broadcasting signal into a specific channel (CH3 or CH4), and providing the converted signal to the specific channel of the analog TV;
tuning an analog broadcasting signal in the broadcasting signal, converting the tuned broadcasting signal into a broadcasting signal of abase band, and providing the converted signal to the analog TV; and
tuning a specific digital RF signal of a digital broadcasting signal, converting the tuned signal into an IF signal, providing the converted signal to digital TV.

9. The method of claim 8, wherein the specific digital RF signal is a signal modulated with at least one of 64-QAM and 256-QAM schemes.

10. The method of claim 8, wherein the analog broadcasting signal is at least one of NTSC (National Television System Committee), PAL (Phase Alternation Line) and SECAM (Sequential Couleur a Memoire) standards.

11. The method of claim 8, further comprising controlling a gain of the broadcasting signal.

12. The method of claim 6, further comprising compensating for an attenuation of the broadcasting signal that occurs during said distributing.

13. The method of claim 6, said processing method being determined by sensing the received broadcasting signal to determine whether the received broadcasting signal is analog or digital.

14. The method of claim 6, said processing method being determined by sensing the received broadcasting signal to determine whether the received broadcasting signal is according to an Open cable standard or a digital cable broadcasting standard.

15. The method of claim 6, further comprising sending a selection signal to the broadcasting service provider.

16. An apparatus for processing a broadcast signal, comprising:
a receiving unit configured to receive a broadcasting signal and a selection signal, the receiving unit being configured to prevent the broadcasting signal and the selection signal from influencing each other, said receiving unit configured to send the selection signal to a cable provider; and
a signal distribution unit configured to receive the broadcasting signal from the receiving unit, the signal distribution unit being configured to distinguish whether the received broadcasting signal is analog or digital and being configured to send the broadcasting signal to an analog processing unit when the broadcasting signal is analog and being configured to send the broadcasting signal to a digital processing unit when the received broadcasting signal is digital.

17. The apparatus of claim 16, the analog processing unit being configured to process received analog broadcasting signals according to one of NTSC, PAL and SECAM standards.

18. The apparatus of claim 16, the digital processing unit being configured to process received digital broadcasting signals according to one of 64-QAM and 256-QAM transmission standards.

19. The apparatus of claim 16, said signal distribution unit being configured to sense whether the received broadcasting signal is according to an Open Cable standard or a digital cable broadcasting standard.

20. The apparatus of claim 19, the analog processing unit and the digital processing unit both being configured to process received broadcasting signals based on said sensing in said signal distribution unit.
